(19) United States
(12) Patent Application Publication
(10) Pub. No.: US 2021/0402454 A1
(43) Pub. Date: Dec. 30, 2021

(54) PUNCHER

(71) Applicant: Panasonic Intellectual Property Management Co., Ltd., Osaka (JP)

(72) Inventors: MASAYUKI TAKAHASHI, Osaka (JP); KEITARO FUJII, Osaka (JP)

(21) Appl. No.: 17/347,455

(22) Filed: Jun. 14, 2021

(30) Foreign Application Priority Data
Jun. 29, 2020 (JP) 2020-111039

(51) Int. Cl. B21D 28/26

(52) U.S. Cl. CPC B21D 28/26

(57) ABSTRACT

There is provided a puncher that punches a flat plate-shaped workpiece with a punch and a die facing each other, the puncher including: at least four sensors that are provided on a same plane orthogonal to a punching direction and measure loads in three-axis directions; a drive table for driving the die that is loaded and the at least four sensors in two-axis directions orthogonal to the punching direction and a rotation direction around the punching direction; and a controller.

### BACKGROUND

### 1. Technical Field

The present disclosure relates to a puncher for punching a workpiece such as a metal, a plastic, or a composite material, and a shearing device.

### 2. Description of the Related Art

The method of punching a plate-shaped material using a pair of precisely aligned molds is extremely common and is widely used in the industrial field. However, although the technology in this field has evolved with the times, the essential issues often remain the same.

It is well known that the optimum clearance between a male and female mold punch and a die varies depending on the thickness of the material to be punched, and a specific value of the clearance is about 7% of the material thickness. In recent years, amorphous metals and film resins having a thickness of 30 micrometers or less may be processed, and such thin materials have a mold clearance of 1 to 3 micrometers. Since the clearance value is a value realized after assembling the mold, the clearance value cannot exceed the processing accuracy and reproducibility of each element component. In addition, there is currently no practical method for confirming the accuracy of the clearance value after assembling the mold. In particular, the clearance accuracy after assembling the mold is very important because the clearance accuracy has a strong correlation with the life of the mold and the processing quality. However, the high-precision assembly technology of these molds is left to skilled technicians, and the technology of quantification has not been established. Therefore, after assembling the mold, if an abnormality is found in a punching test, it is common to disassemble the mold again and scrape each part to readjust the assembly.

When the punch and the die have an alignment error, the clearance between the punch and the die is not uniform, and similarly, the processing quality is not uniform. Depending on the degree of clearance non-uniformity, it is expected that the lifetime of a tool will also be shortened. If the alignment error is relatively large, the punch and die collide with each other, resulting in immediate breakage.

In general, the cumulative value of the processing accuracy of a mold component is the misalignment of a shaft core, so it is rare that there is no alignment error in an initial assembly adjustment.

In view of such a situation, a puncher that can be easily aligned so that the punch and the die are concentric after the mold assembly has been proposed (see Japanese Patent Unexamined Publication No. 2015-178129). A method of adjusting the punch and the die so as to be concentric, which is described in Japanese Patent Unexamined Publication No. 2015-178129, will be described.

The disclosure content described in Japanese Patent Unexamined Publication No. 2015-178129 states that the punching load is large when a positional deviation occurs. On the other hand, if the positional deviation does not occur, it is said that the load is small. That is, if punching is performed with an alignment error between the punch and the die, the processing resistance increases. On the other hand, if punching is performed without an alignment error, the processing resistance becomes low. In this way, since the magnitude of a processing resistance value changes depending on the presence or absence of an alignment error, it is indicated that the misalignment of the shaft cores can be adjusted at a precision of 1 micrometer or less by operating a position adjuster installed below the die so that the processing resistance value is smallest.

### SUMMARY

A puncher according to one embodiment of the disclosure is a puncher that punches a flat plate-shaped workpiece with a punch and a die facing each other, the puncher including: at least four sensors that are provided on a same plane orthogonal to a punching direction and measure loads in three-axis directions; a drive table for driving the die that is loaded and the at least four sensors in two-axis directions orthogonal to the punching direction and a rotation direction around the punching direction; and a controller.

### BRIEF DESCRIPTION OF THE DRAWINGS

FIG. 1A is a conceptual view of a punch-die alignment error in punching;

FIG. 1B is a conceptual view of a punch-die alignment error in punching;

FIG. 2A is a view illustrating an alignment error detection principle in a translational (X, Y) direction according to Exemplary Embodiment 1 of the present disclosure;

FIG. 2B is a view illustrating the alignment error detection principle in the translational (X, Y) direction according to Exemplary Embodiment 1 of the present disclosure;

FIG. 3A is a view illustrating the alignment error detection principle in a rotation direction around a Z axis according to Exemplary Embodiment 1;

FIG. 3B is a view illustrating the alignment error detection principle in a rotation direction around a Z axis according to Exemplary Embodiment 1;

FIG. 4 is a view illustrating a disposition example of a load sensor according to Exemplary Embodiment 1;

FIG. 5A is a view illustrating a calibration method according to Exemplary Embodiment 1;

FIG. 5B is a view illustrating a calibration method according to Exemplary Embodiment 1;

FIG. 6 is a view illustrating an example of a triaxial (X, Y, γ) drive table according to Exemplary Embodiment 1;

FIG. 7 is a view illustrating an example in which a load sensor is disposed on the triaxial drive table according to Exemplary Embodiment 1;

FIG. 8A is a view illustrating an adjustment example of matching a punch and a die to a shaft core according to Exemplary Embodiment 1;

FIG. 8B is a view illustrating an adjustment example of matching the punch and the die to the shaft core according to Exemplary Embodiment 1;

FIG. 9 is a view illustrating an example of a puncher according to Exemplary Embodiment 1; and

FIG. 10 is a view illustrating an example of a control method for the triaxial drive table according to Exemplary Embodiment 1.

### DETAILED DESCRIPTIONS

In the configuration of a related art, even if a punching load is measured in a state where it is unknown whether or not an alignment error has occurred during punching, it is difficult to determine whether the load is large or small. The magnitude of the punching load cannot be determined without comparing the magnitude with some load value. That is, in the example of a related art, there is a critical defect that it is not possible to fundamentally determine whether or not an alignment error has occurred. Even if it is possible to determine that “there is an alignment error.”, there is a problem that it is completely unknown in which direction and how much distance of movement can eliminate the alignment error. Therefore, even if a high-precision adjusting member is embedded in the mold as in the example of the related art, it is not possible to eliminate the misalignment between the punch and the die.

In addition to that, in the example of the related art, since the position adjuster is installed directly under the die, there is a problem that a punched “punch residue” cannot be discharged to the outside of the die, and the puncher cannot be used in mass production as a general puncher as it is.

The present disclosure is to solve the above-mentioned problem in the related art, and an object of the present disclosure is to provide a puncher capable of eliminating an alignment error in a short time by obtaining the magnitude and direction of an alignment error between a punch and a die.

A puncher of the present disclosure is a puncher that punches a flat plate-shaped workpiece with a punch and a die facing each other, the puncher including: at least four sensors that are provided on a same plane orthogonal to a punching direction and measure a load in three directions; a drive table for driving the loaded die and the sensors in a two-axis direction orthogonal to the punching direction and a rotation direction around the punching direction; and a controller.

As described above, according to the puncher and method of the present disclosure, it is possible to eliminate an alignment error in a short time by obtaining the magnitude and direction of the alignment error between a punch and a die. Specifically, in this way, when the puncher is provided with four load measuring instruments in three (X axis, Y axis, and Z axis) directions, it is possible to calculate a moment (Mx, My, Mz) around three axes (α axis, β axis, and γ axis) in addition to a translational force in the triaxial directions. By calculating a resultant-force vector from this result, it is possible to obtain the misalignment direction by calculation when there is an alignment error between the punch and the die.

Further, in the puncher of the present disclosure, a triaxial drive table that can move in the X-axis, Y-axis, and γ-axis (around Z-axis direction) directions is mounted. By using this triaxial drive table, it is possible to obtain an influence coefficient when there is an alignment error between the punch and the die. That is, since the relationship between the deviation amount and the load can be obtained, the movement amount for eliminating the misalignment can be obtained. Therefore, the misalignment between the punch and the die of the puncher can be adjusted based on the translational force and the moment obtained by the mounted load measuring instruments. This makes it possible to provide a puncher that contributes to high-quality punching. Since a through-hole is provided in the central portion of the triaxial drive table, the punched residue (or product) can be discharged in the same manner as in the method of the related art.

In a second puncher in the present disclosure, the controller unit may perform an acquisition step of acquiring, from the sensors, a load in a one-axis direction orthogonal to the punching direction, among loads generated during first punching, a storage step of storing a relative position between the punch and the die during the first punching, a drive step of driving the drive table so that the relative position between the punch and the die is moved in the one-axis direction by a predetermined distance, and a re-acquisition step of acquiring, from the sensors, a load in the one-axis direction orthogonal to the punching direction, among loads generated during second punching after the driving step so that calibration in the one-axis direction is performed.

By carrying out this step, when an alignment error occurs in the one-axis direction, the distance to be moved in order to eliminate the alignment error can be calculated from the load change in the one-axis direction.

In a third puncher in the present disclosure, based on the loads acquired in the acquisition step and the re-acquisition step, and the predetermined distance, the controller may calculate an amount of load change per unit distance in the one-axis direction.

By performing this series of operations, it is necessary to obtain the influence coefficient when the punch and the die are misaligned. That is, calibration is performed when an alignment error occurs in the misaligned direction.

In a fourth puncher in the present disclosure, based on a punching load, acquired from the sensors, in a one-axis direction orthogonal to the punching direction generated during punching and the amount of load change, the controller may drive the drive table so that the relative position between the punch and the die is moved in the one-axis direction and in a direction in which the punching load is reduced.

By carrying out this step, since the direction and distance of the alignment error between the punch and the die can be obtained, by driving the triaxial drive table in that direction, the shaft cores of the punch and the die can be completely matched.

In a fifth puncher in the present disclosure, the controller may perform a calculation step of calculating a moment around a first axis direction orthogonal to the punching direction based on a load in the punching direction generated during first punching, a storage step of storing a relative position between the punch and the die during the first punching, a drive step of driving the drive table so that the relative position between the punch and the die is moved in a second axis direction orthogonal to the punching direction and the first axis direction by a predetermined distance, and a re-calculation step of calculating a moment around the first axis direction based on a load in the punching direction generated during second punching after the drive step so that calibration in the first axis direction is performed.

By carrying out this step, when an alignment error occurs in the first axis direction, the distance in the first axis direction to be moved in order to eliminate the alignment error can be calculated from the moment change around the first axis.

In a sixth puncher in the present disclosure, based on the moments calculated in the calculation step and the re-calculation step, and the predetermined distance, the controller may calculate an amount of moment change per unit distance in the first axis direction.

By performing this series of operations, it is necessary to obtain the influence coefficient when the punch and the die are misaligned. That is, calibration is performed when an alignment error occurs in the misaligned direction.

In a seventh puncher in the present disclosure, based on the loads, acquired from the sensors, in the punching direction generated during punching and the amount of moment change, the controller may drive the drive table so that the relative position between the punch and the die is moved in the first axis direction and in a direction in which the moment is reduced.

By carrying out this step, since the direction and distance of the alignment error between the punch and the die can be obtained, by driving the triaxial drive table in that direction, the shaft cores of the punch and the die can be completely matched.

In an eighth puncher in the present disclosure, the controller may perform a punching calculation step of calculating a moment around the punching direction based on respective loads in two-axis directions orthogonal to the punching direction generated during first punching, a storage step of storing a relative position between the punch and the die during the first punching, a drive step of driving the drive table so that the relative position between the punch and the die is rotated around the punching direction by a predetermined angle, and a punching re-calculation step of calculating a moment around the punching direction based on respective loads in two-axis directions orthogonal to the punching direction generated during second punching after the drive step so the calibration around the punching direction is performed.

By carrying out this step, when a rotation misalignment around the punching direction of the shaft core occurs, the angle in the punching direction that is rotationally misaligned can be calculated from the moment change around the punching direction.

In a ninth puncher in the present disclosure, based on the moments calculated in the punching calculation step and the punching re-calculation step, and the predetermined angle, the controller may calculate an amount of punching moment change per unit angle around the punching direction.

By performing this series of operations, it is necessary to obtain the influence coefficient when the punch and the die are misaligned. That is, calibration is performed when an alignment error occurs at a misaligned angle.

In a tenth puncher and a method in the present disclosure, based on the moment around the punching direction generated during punching and the amount of punching moment change, the controller drives the drive table so as to rotate the relative position between the punch and the die in a direction around the punching direction and in which the moment is reduced.

By performing this step, since the angle of rotational misalignment around the punching direction of the punch and die can be obtained, by driving the triaxial drive table in that direction, the angle misalignment of the punch and the die can be completely matched.

The present disclosure provides a mold assembly accuracy that is close to the processing accuracy of a mold member by numerically managing and controlling the high-precision assembly technology achieved by the experience of skilled technicians and a huge amount of time in punching, which requires higher precision. As a result, the assembly accuracy of the punching mold has been dramatically improved, providing a high-precision punching component. In addition, since the variation in mold life has been reduced, it is possible to find a secondary effect of making the mold maintenance cycle and cost control extremely easy.

### Exemplary Embodiment 1

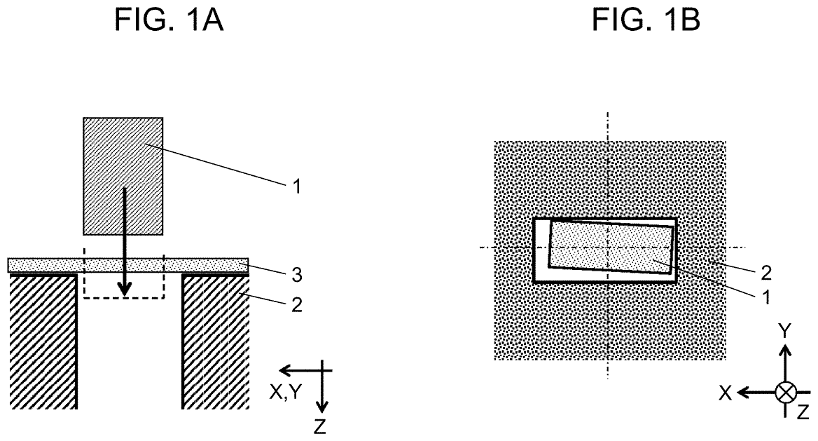

Hereinafter, a puncher according to Exemplary Embodiment 1 will be described with reference to drawings. FIGS. 1A and 1B are views illustrating an alignment error (hereinafter, an “eccentricity” error is called for the X and Y axes and a “rotational” error is called for the γ axis) occurring when workpiece 3 is punched by using punch 1 and die 2 in punching. In FIG. 1A, a side sectional view during punching is schematically drawn, and in FIG. 1B, a top view after the punching is drawn schematically. The punching mold is assembled by a skilled technician, but generally when the clearance between punch 1 and die 2 is required to have an accuracy of 10 micrometers or less, there is no way to measure that the clearance is uniform even if there is no interference and collision. That is, as illustrated in FIG. 1B, the clearance between punch 1 and die 2 is not uniform. It is extremely difficult to meet the recent demand of assembly accuracy with a clearance of 3 micrometers or less because the assembly accuracy is close to the processing accuracy of a mold component alone, and even if the assembly accuracy can be realized, it will take a long time.

If punching is started in such a state in mass production, burrs exceeding the standard may be generated in punched workpiece 4, which may cause a defect. However, since a defect of burrs is easily noticed, if there is a problem, re-adjustment is performed by re-assembling the mold. On the other hand, there may be a problem that the die life of punch 1 and die 2 becomes short. If the mold life is shorter than an originally designed life, the manufacturing cost will increase. Therefore, in order to maintain a stable manufacturing cost at all times, it is important to reduce errors associated with mold assembly as much as possible.

The alignment error in which the clearance between punch 1 and die 2 illustrated in FIG. 1B is not uniform may be an error of five degrees of freedom in an X translational direction, a Y translational direction, a rotation direction around a Z axis (γ axis), a rotation direction around an X axis (α axis), and a rotation direction around Y axis (β axis). However, since the amount of interference (push depth) between punch 1 and die 2 after punching is generally two or three times the thickness of the workpiece in the actual punching and practically, errors in the α axis (Mx output described below) and the β axis (My output described below) are not issues, the following describes a method for detecting and eliminating an error in three degrees of freedom, X translation (X described below), Y translation (Y described below), and γ-axis rotation (Mz described below). However, it goes without saying that in the configuration of the present disclosure described in detail below, errors in α rotation and β rotation can be detected in the same manner.

As illustrated in FIG. 1B, the alignment error between punch 1 and die 2 is generally included simultaneously with three errors of X translation, Y translation, and γ rotation, but each is described separately here.

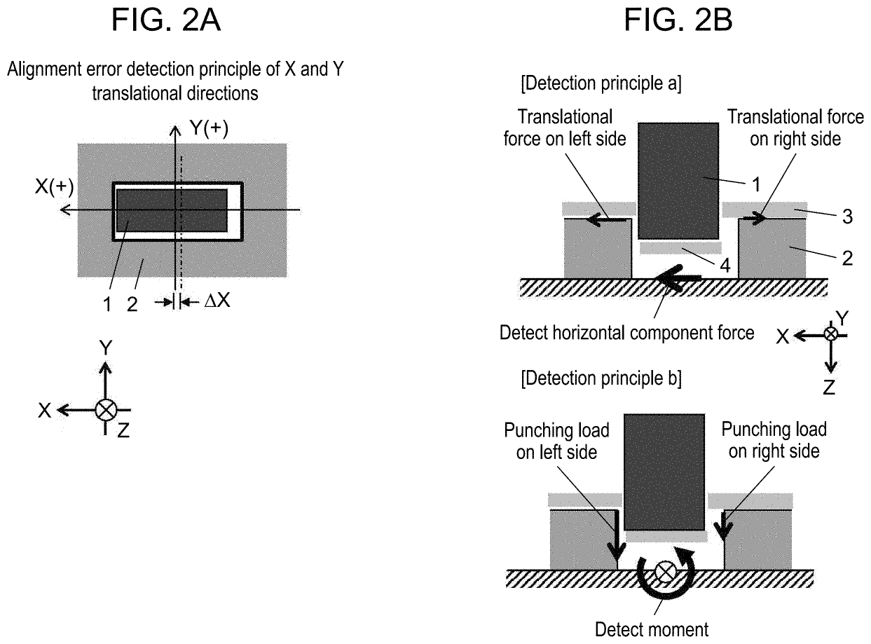

FIGS. 2A and 2B illustrate an alignment error detection principle in the X and Y translational directions. FIG. 2A illustrates a state in which the die 2 is eccentric with respect to the punch 1 by ΔX. Here, in order to simplify the problem, the central axes of the punch 1 and the die 2 are eccentric only in the X-axis direction, and there is no error in the Y-axis direction and the γ-axis rotation direction.

Next, the principle of detecting a translation error is illustrated in FIG. 2B. In [Detection Principle a] in the upper part of the same drawing, the load in the translational direction (in this example, the X-axis direction) generated during punching may be detected. When punching is performed in a state where punch 1 and die 2 are eccentric and set, a translational force (load in the X direction in the drawing) is generated between punch 1 and die 2 such that die 2 moves away from punch 1, but translational forces are generated in opposite directions on the right side and the left side. However, if punch 1 and die 2 are eccentric, the translational force on the biased side becomes large, and therefore, if a load sensor is installed below die 2 (not illustrated), the translational force can be detected. In other words, when punch 1 and die 2 are not eccentric, the translational forces generated during the punching are balanced on the right side and the left side. Therefore, when the translational force below die 2 is zero, it is considered that eccentricity has not occurred.

[Detection Principle b] is illustrated in the lower part of FIG. 2B. Here, the punching load generated between punch 1 and die 2 is used. Specifically, when punching is performed in a state where the punch 1 and the die 2 are eccentric and set, punching loads are generated at the cutting edge portion on the right side and the cutting edge portion on the left side of die 2. Since punch 1 and die 2 are eccentric, the punching load on the biased side becomes large. Therefore, if a load sensor is installed below die 2 (not illustrated), the punching load generated on the left side and the punching load generated on the right side can be detected. From the detected punching load, the moment around the Y axis (β axis) can be calculated in the example of the same drawing. In other words, when punch 1 and die 2 have no eccentricity, the left and right punching loads generated during the punching are the same on the right side and the left side. Therefore, when the moment below die 2 is zero, it is considered that eccentricity has not occurred.

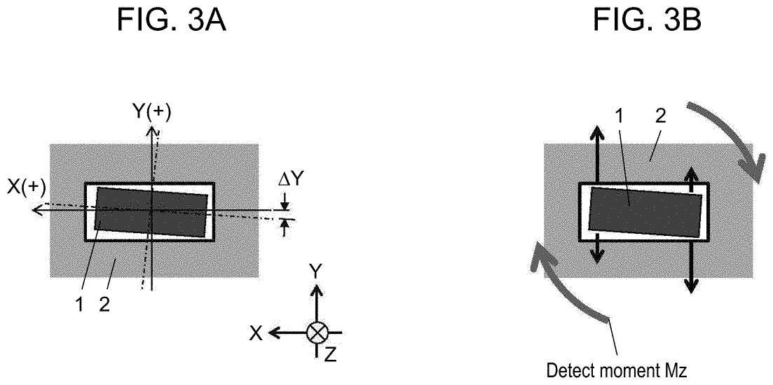

FIGS. 3A and 3B illustrate an error detection method for the γ axis (rotational direction around the Z axis). Here, a plate-shaped workpiece is not drawn as if the workpiece exists. FIG. 3A is a schematic view in which only an error of the γ axis has occurred. In FIG. 3B, since only the error of the γ axis has occurred, when punching is performed, a punching load is generated in an X-Y plane according to the clearance between punch 1 and die 2, and as illustrated in the drawing, the moment (Mz) around the Z axis (γ axis) appears as a result. Therefore, if the punching load in the X-Y plane is detected, the moment Mz can be obtained by calculation.

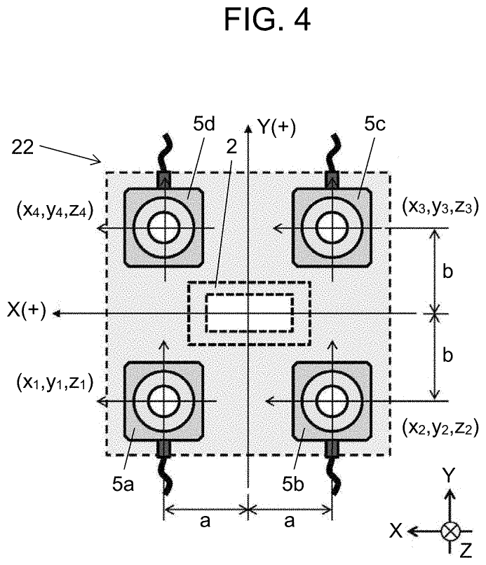

A disposition example of the load sensor of the present disclosure is illustrated in FIG. 4. Load sensors 5 (a to d) can measure the load in the three-axis directions and are installed below lower mold 22 including die 2. The load generated on die 2 during punching is applied to four load sensors 5 via lower mold 22. If load sensors 5 are disposed symmetrically with respect to the center of gravity of die 2, the calculation of the moment to be detailed later becomes easy. In the example of FIG. 4, four sensors are disposed symmetrically with respect to the Y axis at a distance a and similarly, symmetrically with respect to the X axis at a distance b. Needless to say, if the number of load sensors is at least three, the same function as the present disclosure can be realized.

Load X in the X-axis direction is a value obtained by adding up the X-direction components of four load sensors 5 as illustrated in Equation 1 below.

X=x₁+x₂+x₃+x₄ [Equation 1]

Load Y in the Y-axis direction is a value obtained by adding up the Y-direction components of four load sensors 5 as illustrated in Equation 2 below.

Y=y₁+y₂+y₃+y₄ [Equation 2]

Load Z in the Z-axis direction is, that is, punching load Z. Load Z is a value obtained by adding up the Z-direction components of four load sensors 5 as illustrated in the Equation 3 below.

Z=z₁+z₂+z₃+z₄ [Equation 3]

Moment Mx around the X axis (α axis) is calculated from the Z-direction components and distances of four load sensors 5 as illustrated in Equation 4 below.

Mₓ=b(z₁+z₂−z₃−z₄) [Equation 4]

Moment My around the Y axis (β axis) is calculated from the Z-direction components and distances of four load sensors 5 as illustrated in Equation 5 below.

M_{z}=a(z₁−z₂−z₃+z₄) [Equation 5]

Moment Mz around the Z axis (γ axis) is calculated from the X-direction components, the Y-direction components, and the distances of four load sensors 5 as illustrated in Equation 6.

M_{z}=b(x₁+x₂−x₃−x₄)+a(y₁−y₂−y₃+y₄) [Equation 6]

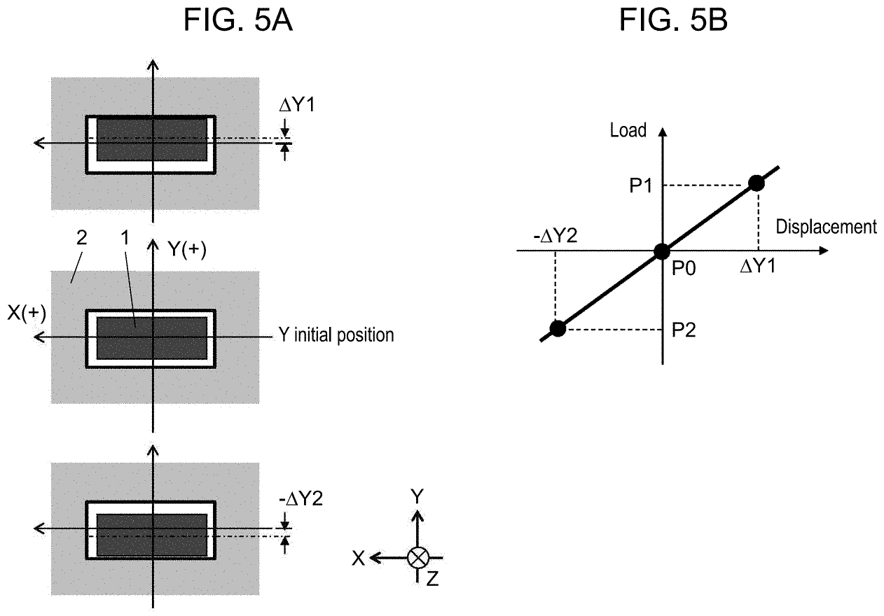

After punching, the outputs from the four load sensors illustrated in FIG. 4 are calculated based on the above equations via load detector 34 such as a charge amplifier described later, and loads and moments in the six degrees of freedom direction are output. As can be seen from FIGS. 4, 5A and 5B, when punching is performed with a mold having a completely symmetrical structure, the values of (Equation (1)), (Equation (2)), (Equation (4)), (Equation (5)), and (Equation (6)) become zero, and only a punching load (Equation (3)) occurs. As described at the beginning, moments Mx and My, which are the outputs of (Equation (4)) and (Equation (5)), are not used in the example of the present exemplary embodiment, and will not be described further.

On the other hand, since most of the actual molds have an alignment error between punch 1 and die 2, moment Mz is output from the translational force in the X direction of (Equation (1)), the translational force in the Y direction of (Equation (2)), and (Equation (6)). First, the combined vector direction of (Equation (1)) and (Equation (2)) is the eccentric direction in the X-Y plane. However, at this point, only the eccentric direction is known, and the amount of eccentricity (distance) is unknown. Similarly, for Mz, which is a component of the γ-axis rotation error, the quantitative angle is indefinite, and only the rotation direction in which the error has occurred is known.

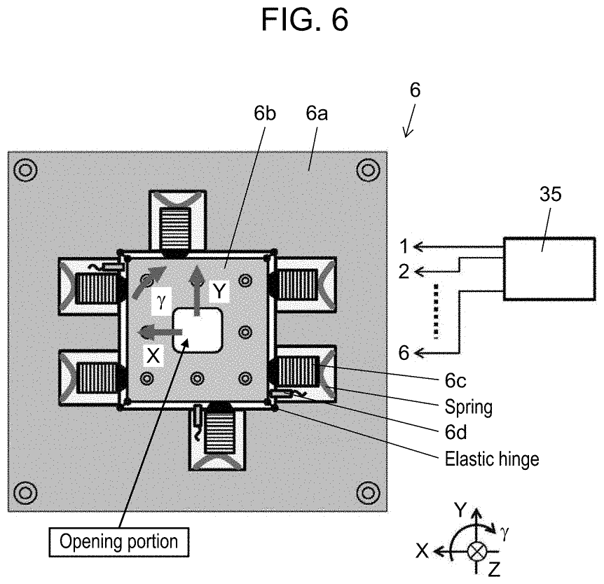

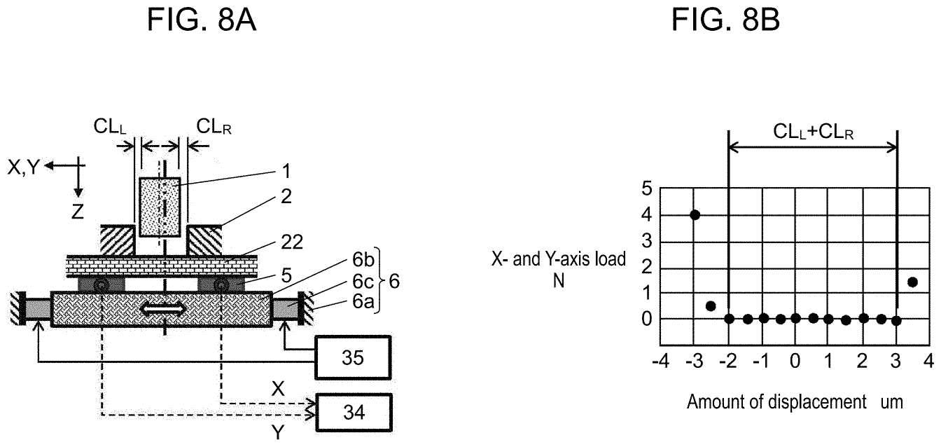

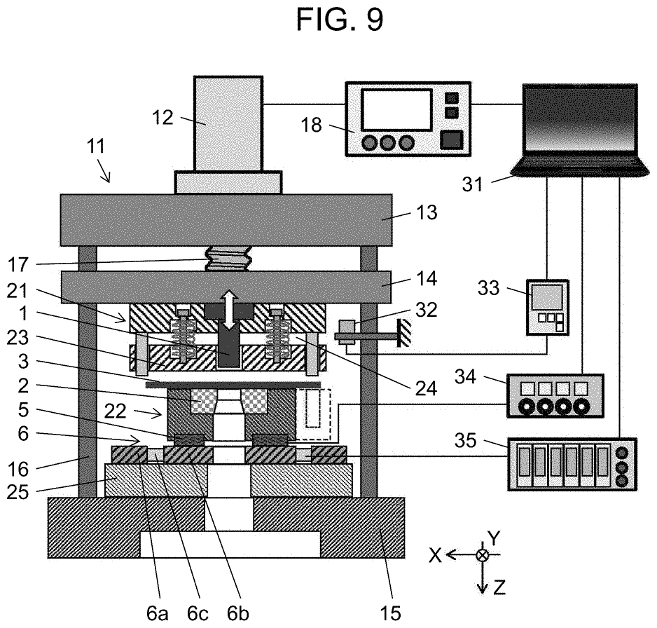

Next, a method (calibration method) for obtaining the relationship between the amount of eccentricity (distance) and a horizontal component force will be described below. FIGS. 5A and 5B illustrate a calibration method in a direction of the horizontal component force (Y-axis direction in the drawing). For the operation here, the load sensor described with reference to FIG. 4 and the triaxial drive table (FIGS. 6 and 8A) described later are used. In FIG. 5A, punching is performed, but a workpiece is not drawn as if the workpiece exists. The following calibration method is performed by computer 31 (see FIG. 9).

Computer 31 is initially installed as the initial position of die 2 illustrated in FIG. 5A in such a way as to be the center in the Y-axis direction with respect to punch 1 (this central installation is described in FIGS. 8A and 8B), and punching is performed. The translational force (Equation (2)) detected at this time in the Y-axis direction is defined as P0. Computer 31 stores translational force P0 in the Y-axis direction.

Computer 31 then moves die 2 by ΔY1 by using the triaxial drive table described later and punches die 2 there. The translational force in the Y-axis direction detected at this time is defined as P1.

Similarly, computer 31 moves die 2 to the position of −ΔY2 by using the triaxial drive table and punches die 2 there. The translational force in the Y-axis direction detected at this time is defined as P2.

Computer 31 summarizes the results of the three experiments in FIG. 5B into a calibration curve. In the drawing, three points are plotted with the horizontal axis representing the distance and the vertical axis representing the Y-axis load. Computer 31 connects these three points by a straight line (linear approximation) or a polynomial approximation expressed by a polynomial. Computer 31 may calculate the slope of the calibration curve, that is, the amount of load change per unit distance in the Y-axis direction. Of course, it goes without saying that an accurate calibration curve may be drawn by adding more experimental data for accuracy. By doing so, the relationship between the minute distance in the Y-axis direction and the translational force in the Y-axis direction becomes clear. Although the Y axis has been described as an example in FIGS. 5A and 5B, the X axis can be drawn in the same manner.

A calibration curve can be similarly drawn for moment Mz of Equation (6). Describing in the same manner as in the example of FIG. 5B, a calibration curve may be drawn so that the horizontal axis is a minute rotation angle around the Z axis and the vertical axis is moment Mz. The slope of this calibration curve means the amount of change in moment Mz per unit angle around the Z axis.

Similarly, the method described in [Detection Principle b] of FIG. 2B can be considered in the same manner. Describing in the same manner as the example of FIG. 5B, when performing calibration in the Y-axis direction, a calibration curve may be drawn so that the horizontal axis is a minute distance in the Y direction and the vertical axis is moment Mx around the X axis.

Similarly, when performing calibration in the X-axis direction, calibration in the X-axis direction is possible by drawing a calibration curve so that the horizontal axis is a minute distance in the X-axis direction and the vertical axis is moment My around the Y axis. By doing so, the relationship between the minute distance in the X-axis direction and moment My becomes clear.

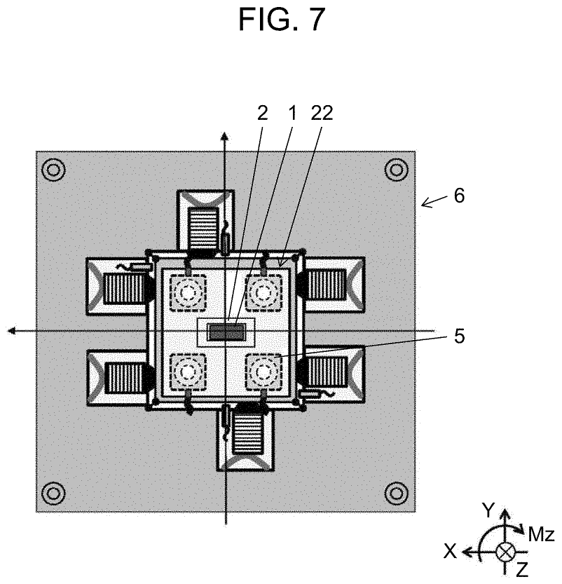

FIGS. 6 and 7 illustrate an example of the triaxial drive table used in the present exemplary embodiment. Since the purpose of this drive table is to align the punch and die, it is necessary to move the three axes of X translation, Y translation, and γ-axis rotation. Since the movable unit of the drive table is the assembly adjustment level of the mold, it goes without saying that the drive table has a resolution of 0.1 micrometer or less as well as 1 micrometer. However, since the drive table is used in punching, it goes without saying that a shocking load of 10,000 N or more is generated in the Z-axis direction (punching axis direction) of the movable surface, although the load depends on the object to be processed. Therefore, it cannot be said that the triaxial drive table only needs to move precisely. Even if a shocking punching load is applied, the table will break, or even if the table does not break, the table cannot be used for punching applications with a configuration that facilitates elastic deformation. It is desirable that a through-hole is provided in the central portion of the movable surface on which the mold is mounted. This is because it is necessary to have a hole for discharging the punched residue (in some cases, the product itself) and dropping the residue downward. Therefore, in a configuration such as a general movable table in which a hollow portion is provided to include a feed mechanism (for example, a ball screw) in the center of the movable portion, the rigid surface and the through-hole in the central portion cannot satisfy required specifications. The triaxial drive table illustrated in FIG. 6 has a configuration that satisfies the above-mentioned required specifications and is considered to be suitable for punching applications, and will be described in detail below.

FIG. 6 illustrates a basic configuration of triaxial drive table 6. Inside plate-shaped frame 6a, there is movable portion 6b having a through-hole portion in the center. Movable portion 6b has a size that allows a load sensor and a lower die (including a die) to be mounted as described later. Movable portion 6b has a plate shape and does not have a mechanical portion or a hollow portion in the Z-axis direction, which is the punching direction.

In triaxial drive table 6 of the present disclosure, movable portion 6b in the center is supported via frame 6a and an elastic hinge. Further, piezoelectric element (PZT) 6c, which serves as a drive source, is in contact with frame 6a and movable portion 6b via a pressurizing spring. Movable portion 6b driven by the piezoelectric element during operation is measured by distance sensor 6d.

As illustrated in FIG. 6, the Y-axis direction is a set of two piezoelectric elements disposed so as to face each other and one displacement sensor. The X-axis direction is a combination of four piezoelectric elements and two displacement sensors disposed so as to face each other as illustrated in FIG. 6. The γ-axis rotation can be given a rotational operation by driving the piezoelectric elements disposed in the X-axis direction. Similarly, regarding the rotation angle of the γ axis, the rotation angle can be accurately detected by the two displacement sensors disposed in the X axis. Needless to say, these series of operations are controlled by external piezoelectric element controller 35.

FIG. 7 illustrates a view in which four load sensors are installed on triaxial drive table 6 and lower mold 22 is disposed on the load sensors, and illustrating the disposition of punch 1 and die 2 in a way that can be understood. In the present disclosure, when punching is performed as described above, four load sensors 5 detecting a triaxial load, installed below the lower mold, detect the loads, the result is calculated by an arithmetic unit (not illustrated), and the triaxial drive table is operated so that the alignment error between punch 1 and die 2 is eliminated. For example, computer 31 may detect the punching load in the Y-axis direction. Computer 31 may calculate the amount of load change per unit distance in the Y-axis direction based on the calibration curve in the Y-axis direction. Computer 31 may specify a position where the punching load becomes smaller based on the detected punching load and the amount of load change. Computer 31 may drive triaxial drive table 6 to move the relative position between punch 1 and die 2 to the specified position in order to eliminate the alignment error. Computer 31 may perform similar processing in the X-axis direction and the γ-axis direction. In the γ-axis direction, computer 31 may specify an angle at which the moment becomes smaller. Computer 31 may move the relative angle between punch 1 and die 2 to the specified angle in order to eliminate the alignment error.

FIGS. 8A and 8B illustrate an example of eliminating the alignment error between punch 1 and die 2 that can be realized by the configuration of the puncher of the present disclosure. This is a method different from FIGS. 2A, 2B, 3A, and 3B. FIG. 8A is a schematic view of the alignment error adjusting method, and FIG. 8B illustrates the relationship between the amount of displacement and the load during adjusting the alignment error. Since the alignment adjustment operation by this method does not perform punching, no workpiece is required. In this adjustment work, as illustrated in FIG. 8A, four load sensors 5 are installed on triaxial drive table 6 in the puncher, and lower mold 22, upper mold 21 (not illustrated), and punch 1 are mounted thereon.

FIG. 8A is carried out in a state where the punch is inserted into the die (for example, “bottom dead center” during punching). From this state, when punch 1 is operated little by little (for example, every 0.5 micrometer) in the Y direction, punch 1 and the inner wall surface of die 2 come into contact with each other. When the values of load sensors 5 at that time are monitored and output, a view can be drawn as illustrated in FIG. 8B. The horizontal axis is the distance traveled by the triaxial drive table, and the vertical axis is the output values of load sensors 5 in the moving direction. There is a clearance between punch 1 and die 2, and even if the triaxial drive table is operated in 0.5 micrometer steps, the punch and the die do not come into immediate contact. At the position where punch 1 and die 2 do not come into contact with each other, the load is zero. However, when the punch and the die come into contact with each other, the load increases, so it is easy to determine where the punch and the die have come into contact. In the example of FIG. 8B, it can be seen that 5 micrometers between −2 and 3 micrometers is the clearance between punch 1 and die 2. From this, it is possible to know which position is the position where the clearance is even. When this operation is performed in the X-axis direction and then in the Y-axis direction, only the rotation around the γ axis remains as the alignment error between punch 1 and die 2. Regarding the rotation error around the γ axis, the same operation can be performed only when the horizontal axis in FIG. 8B is the rotation angle and the vertical axis is moment Mz.

If the alignment error detection principle illustrated in FIGS. 2A, 2B, 3A and 3B and the calibration operation illustrated in FIGS. 5A and 5B are carried out, there is an advantage that the alignment error can be eliminated even during the processing. On the other hand, the method of eliminating the alignment error in FIGS. 8A and 8B has an advantage that the alignment error can be eliminated in a static state without punching. Since these methods can be used properly within the same puncher configuration, the optimum method may be appropriately selected and carried out.

FIG. 9 illustrates the puncher according to the exemplary embodiment of the present disclosure. In FIG. 9, a main configuration will be described.

The puncher in FIG. 9 is servo-screw type puncher 11. The puncher in the present disclosure does not need to be a servo-screw type, but this type of puncher is considered to be suitable for implementing the present disclosure because of very good controllability. Servo-screw type puncher 11 includes servomotor 12 installed to upper plate 13; ball screw 17 connected to a rotating portion of servomotor 12; and movable plate 14 at the tip, and movable plate 14 is operated along shaft 16 by the forward and backward rotation of servomotor 12. Servomotor 12 is adapted to rotate based on a command from controller 18 of the puncher.

Upper mold 21, which is half of the mold, is attached to movable plate 14. The main configuration of upper mold 21 is stripper 23 that contains punch 1 and serves as a material retainer at the tip. A predetermined initial load is applied to stripper 23 by stripper spring 24 which is a compression spring.

Below upper mold 21, lower mold 22 containing die 2 is installed on gantry 15. Gantry 15 is connected to upper plate 13 by four shafts 16, and upper mold 21 and lower mold 22 fastened to movable plate 14 move up and down relatively. Workpiece 3 is installed between upper mold 21 and lower mold 22 which are disposed so as to face each other.

Load sensors 5 for detecting four three-axis loads are installed under lower mold 22. Further, the load sensors are fastened to movable portion 6b of triaxial drive table 6. Load sensors 5 are connected to external load detector 34, and the load values of each of the four three axes are calculated, and the moment is also calculated.

Frame 6a of the triaxial drive table is fastened to base plate 25. In this configuration, movable portion 6b of the triaxial drive table slides on base plate 25 when piezoelectric element 6c moves. A base plate is made of gunmetal between base plate 25 and movable portion 6b so that smooth movement is possible. As mentioned above, a punching load is applied to the movable portion, and a shocking load of 10,000 N or more is applied depending on the conditions, but since movable portion 6b itself is a thick plate-shaped metal member, as can be seen, no deformation or the like is generated by the punching load. Although piezoelectric element 6c, which is a drive unit, is a precision component that is easily damaged, but since the piezoelectric element is disposed at a position not affected by the punching load during punching, breakage does not occur. As can be seen from FIG. 9, the punched residue of workpiece 3 during punching is discharged further downward from the inside of die 2 and the inside of the lower mold through the center of movable portion 6b of the triaxial drive table.

In the triaxial drive table, each piezoelectric element 6c and each distance sensor 6d (not illustrated here) are connected to piezoelectric element controller 35.

Next, gap sensor 32 provided externally is provided for the purpose of measuring the vertical movement of movable plate 14 with high accuracy. Gap sensor 32 is also connected to externally provided gap sensor amplifier 33.

Control devices (18, 33, 34, and 35) illustrated in the example of the present disclosure are all connected to computer 31, and the amount of eccentricity is calculated in the computer and the amount of movement of the triaxial drive table is calculated based on the result of the calculation, and a command is given to each control device.

Next, the installation of the die in the puncher of the present disclosure will be described. In a general punching mold, the upper mold and the lower mold are connected by a guide post, and the upper mold moves up and down along the guide. On the other hand, in the puncher of the present disclosure, triaxial drive table 6 is mounted and the lower mold moves relative to the upper mold. Therefore, not only a guide post similar to a general mold is unnecessary, but also the movement which is a clearance adjusting function of punch 1 and die 2 is hindered. Instead, the upper mold and the lower mold are mounted on the puncher with high accuracy, and the accuracy of the guide post of the puncher is used to ensure the accuracy. If the initial accuracy is too poor, a collision between punch 1 and die 2 may occur at the beginning. Therefore, for mounting the upper mold and the lower mold, when punch 1 is inserted into die 2, punch 1 is assembled with such accuracy that a collision is not generated, and then surely fixed by using a punch having a guide function for rough adjustment with the die, which is called a pilot punch (not illustrated) in place of the punch of the upper mold. Thereafter, the pilot punch is replaced with official punch 1. In this state, it is confirmed that punch 1 is inserted without colliding with die 2. Specifically, the outputs of load sensors 5 may be monitored so that no load is generated even at the position where punch 1 is inserted into die 2. This mold configuration also has a feature that a low-cost mold configuration can be realized because a guide post and the constituent members thereof are unnecessary when the mold alone is evaluated.

Next, a series of flows will be described for the punching operation in the present exemplary embodiment. It is assumed that the punch 1 and the die 2 are assembled at a level at which the punch 1 and the die 2 do not collide (interfere). The workpiece 3 is installed between the punch 1 and the die 2. The workpiece 3 includes a loader for unwinding, winding, or the like in mass production, but the loader is not important in the present disclosure and will be omitted.

In the punching operation, a command is sent from controller 18 of the puncher to servomotor 12 based on a specified operation pattern (processing program), and upper mold 21 mounted on movable plate 14 moves down. When a predetermined position is reached, a measurement start signal is input from gap sensor 32 to load detector 34, and a load meter starts measurement. However, no load is generated at this stage. When the descent progresses, stripper 23 holds workpiece 3, and a load is generated from this point. As the descent progresses further, stripper spring 24 is compressed according to the position and the stripper load increases, and at the same time, punch 1 moves relative to stripper 23, punching is started at a stage where the punch tip is in contact with workpiece 3, and the punching load is also rapidly increased. Punch 1 moves down further and operates to the bottom dead center even after punching workpiece 3. Thereafter, the punch then reverses itself and moves up. When stripper 23 is separated from workpiece 3 and the punch moves up further, the load measurement is finished based on the position information from gap sensor 32. This series of operations is generally performed in 1 second or less, although it depends on the processing conditions.

Next, the handling of the load obtained by data in the series of processes described above will be described. The data of four installed load sensors 5a to 5d is instantly sent to load detector 34, and the calculations illustrated in Equations 1 to 6 are performed. In particular, X, Y, Mz, or Mx, My, Mz are calculated and determined in computer 31 based on the detection principle of an alignment error described in FIGS. 2A, 2B, 3A, and 3B, and triaxial drive table 6 is driven through piezoelectric element controller 35. However, every time punching is performed, whether to execute such a sequence or to execute the trend data collectively is appropriately determined by an optimum method.

It goes without saying that a series of processes for measuring such a punching load, and then calculating an alignment error between the punch and the die and operating can be realized because the data includes the relationship between the translational load and the distance, the relationship between moments Mx and My and the distance, and the relationship between moment Mz and the angle based on the calibration data described in advance in FIG. 5B, that is, the result of the calibration data that is stored in computer 31.

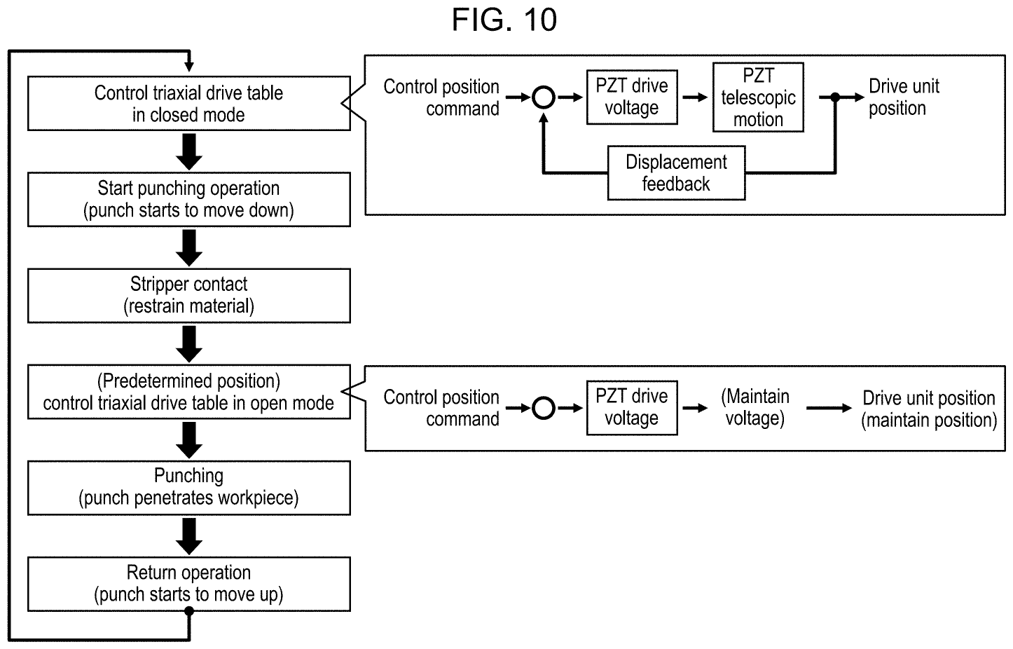

As a highly accurate load measurement data acquisition method, the method illustrated in FIG. 10 is also adopted and will be described. Since the triaxial drive table is designed to operate on the order of nanometers, the triaxial drive table may operate unnecessarily when workpiece 3 is pinched by a stripper load immediately before processing. This is due to processing and assembly errors such as the stripper surface and the lower mold surface not being completely parallel, and the stripper load includes X- and Y-axis components other than the components in the Z-axis direction. At this time, since the force to move lower mold 22 is generated by the X and Y components of the stripper load, there arises a problem that the triaxial drive table tries to push back and operates unnecessarily. Therefore, the unnecessary operation can be eliminated by instantaneously switching the triaxial drive table from closed loop control to open loop control at any position when the upper mold moves down. FIG. 10 illustrates the processing of switching the triaxial drive table from the closed loop control to the open loop control and returning to the closed loop control again after the punching. However, it goes without saying that the position in FIG. 10 for switching from closed loop control to open loop control and the position for changing from open loop control to closed loop control vary depending on the object to be processed and the like, and not necessarily limited to the positions illustrated in FIG. 10. By incorporating the process illustrated in FIG. 10, load measurement with higher accuracy and high reproducibility becomes possible.

The method for eliminating the alignment error between punch 1 and die 2 described with reference to FIGS. 8A and 8B is different from the above-described method. To describe again, there is no need to punch in the alignment method of punch 1 and die 2 described with reference to FIGS. 8A and 8B. This is a method in which the shaft cores of punch 1 and die 2 are aligned in advance and then punched. Basically, punch 1 and die 2 are attached very firmly in the mold, and therefore even if there is a misalignment after assembly, if the misalignment is adjusted, there is nothing that changes even if there is an impact of punching. If punch 1 and die 2 are misaligned during processing, an initial adjustment is performed by the method illustrated in FIGS. 8A and 8B, and during the subsequent processing, the methods of FIGS. 2A, 2B, 3A, and 3B may be used together. Regardless of which method is used, the same can be achieved with the device configuration of the present disclosure.

The puncher and methods of the present disclosure are a puncher and methods for realizing a long lifetime of the mold and high-quality punching because the puncher and the methods have a function of eliminating an alignment error between the punch and the die. Therefore, since the clearance of a tool can be changed as appropriate, the puncher and the methods can also be used in a cutter. For example, when cutting a very thin film having a thickness of several micrometers, for example, a very high-precision clearance adjustment is required, and the present disclosure can be applied to a cutter or the like.

The puncher and method of the present disclosure have a function capable of detecting an alignment error between a punch and a die by calculating a translational force and a moment during punching and further automatically eliminating the alignment error by having a triaxial drive table, and can be applied more widely to a cutter in addition to a device that punches a workpiece such as a metal, a plastic or a composite material.

What is claimed is:

1. A puncher that punches a flat plate-shaped workpiece with a punch and a die facing each other, the puncher comprising:
at least four sensors that are provided on a same plane orthogonal to a punching direction and measure loads in three-axis directions;
a drive table for driving the die that is loaded and the at least four sensors in two-axis directions orthogonal to the punching direction and a rotation direction around the punching direction; and
a controller.

2. The puncher of claim 1,
wherein, the controller performs
an acquisition step of acquiring, from the at least four sensors, a load in a one-axis direction orthogonal to the punching direction, among loads generated during first punching,
a storage step of storing a relative position between the punch and the die during the first punching,
a drive step of driving the drive table so that the relative position between the punch and the die is moved in the one-axis direction by a predetermined distance, and
a re-acquisition step of acquiring, from the at least four sensors, a load in the one-axis direction orthogonal to the punching direction, among loads generated during second punching after the drive step so that calibration in the one-axis direction is performed.

3. The puncher of claim 2,
wherein, based on the loads acquired in the acquisition step and the re-acquisition step, and the predetermined distance, the controller calculates an amount of load change per unit distance in the one-axis direction.

4. The puncher of claim 3,
wherein, based on a punching load, acquired from the at least four sensors, in a one-axis direction orthogonal to the punching direction generated during punching and the amount of load change, the controller drives the drive table so that the relative position between the punch and the die is moved in the one-axis direction and in a direction in which the punching load is reduced.

5. The puncher of claim 1,
wherein, the controller performs
a calculation step of calculating a moment around a first axis direction orthogonal to the punching direction based on a load in the punching direction generated during first punching,
a storage step of storing a relative position between the punch and the die during the first punching, a drive step of driving the drive table so that the relative position between the punch and the die is moved in a second axis direction orthogonal to the punching direction and the first axis direction by a predetermined distance, and
a re-calculation step of calculating a moment around the first axis direction based on a load in the punching direction generated during second punching after the drive step so that calibration in the first axis direction is performed.

6. The puncher of claim 5,
wherein, based on the moments calculated in the calculation step and the re-calculation step, and the predetermined distance, the controller calculates an amount of moment change per unit distance in the first axis direction.

7. The puncher of claim 6,
wherein, based on the loads, acquired from the at least four sensors, in the punching direction generated during punching and the amount of moment change, the controller drives the drive table so that the relative position between the punch and the die is moved in the first axis direction and in a direction in which the moment is reduced.

8. The puncher of claim 1,
wherein, the controller performs a punching calculation step of calculating a moment around the punching direction based on respective loads in two-axis directions orthogonal to the punching direction generated during first punching, a storage step of storing a relative position between the punch and the die during the first punching, a drive step of driving the drive table so that the relative position between the punch and the die is rotated around the punching direction by a predetermined angle, and a punching re-calculation step of calculating a moment around the punching direction based on respective loads in the two-axis directions orthogonal to the punching direction generated during second punching after the drive step so that calibration around the punching direction is performed.

9. The puncher of claim 8,
wherein, based on the moments calculated in the punching calculation step and the punching re-calculation step, and the predetermined angle, the controller calculates an amount of punching moment change per unit angle around the punching direction.

10. The puncher of claim 9,
wherein, based on the moment around the punching direction generated during punching and the amount of punching moment change,
the controller drives the drive table so that the relative position between the punch and the die is rotated around the punching direction and in a direction in which the moment is reduced.
